(19) United States
(12) Patent Application Publication
(10) Pub. No.: US 2025/0089740 A1
(43) Pub. Date: Mar. 20, 2025

(54) PROCESS FOR PREPARING A COARSE DEVITALIZED WHEAT GLUTEN PRODUCT

(71) Applicant: Cargill, Incorporated, Wayzata, MN (US)

(72) Inventors: Virginia Calabuig Pons, Mechelen (BE); Radmilo Colovic, Dusseldorf (DE); Richard Antonius Jacobus Mossel, Roosendaal (NL)

(73) Assignee: Cargill, Incorporated, Wayzata, MN (US)

(21) Appl. No.: 18/729,566

(22) PCT Filed: Jan. 20, 2023
(86) PCT No.: PCT/US2023/060975

§ 371 Date: Jul. 17, 2024

(30) Foreign Application Priority Data
Jan. 20, 2022 (EP) 22152525.6

(51) Int. Cl. A23J 3/18; A23K 10/30; A23K 20/147; A23K 50/80

(52) U.S. Cl. CPC A23J 3/18; A23K 10/30; A23K 20/147; A23K 50/80

(57) ABSTRACT

The invention relates to the field of plant-based proteins, in particular wheat proteins, used in the aqua feed industry. The invention covers a process for preparing a coarse devitalized wheat gluten composition and the product obtained therefrom. The invention also covers an aquafeed product comprising the coarse devitalized wheat gluten composition of the invention and its use. The invention also covers the use of the coarse devitalized wheat gluten composition to at least partially replace other proteins in an aqua feed product, whilst maintaining the overall digestibility.

### CROSS-REFERENCE TO RELATED APPLICATIONS

This application claims the benefit of European Patent Application No. 22152525.6, filed Jan. 20, 2022, which is incorporated by reference herein in its entirety.

### FIELD OF THE INVENTION

The invention relates to the field of plant-based proteins, in particular wheat proteins, used in the aqua feed industry.

### BACKGROUND OF THE INVENTION

With the world population set to reach 8 billion in the next few years, the demand for animal proteins for human consumption continues to grow. Farmed aquatic animals today forms a significant component of the aqua industry and this is expected to grow.

However, the aqua industry is facing challenges to breed more animals more sustainably. As fishmeal, krill meal and other forms of aquatic animal protein become more expensive and less available, breeders, farmers and feed producers have turned increasingly to plant-based sources of protein. One such protein is soybean meal, which costs significantly less than most animal meals. In fact, soybean meal, soy protein concentrates, soybean oil, and other vegetable proteins and oils, can replace from one-third to one-half of the fishmeal in feeds for many farmed species, reducing the need for wild-caught fish for fishmeal. However, consumers are increasingly seeking more sustainably sourced products.

Hence, aqua feed manufacturers are looking for cost-effective, locally sourced, sustainable alternatives, which can replace both soybean meal and aquatic animal-based meal ingredients. Such alternatives must however also be easy to transport, to handle, and to incorporate into aqua feed recipes, be digestible by the aquatic animal, allow for efficient transformation of nutrients into body weight and have the right amino acid profile.

When selecting a raw material many characteristics need to be considered. The science of making fish feed by balancing the properties ingredients from different origins is a considerable challenge. Inherent characteristics, such as nutritional profile (aminoacids, lipids, carbohydrates, vitamins and micronutrients), digestibility, presence of anti-nutritional factors (ANF), but also physical properties, such as processability and functionality are important elements to take into consideration when formulating a diet for aquatic animals.

An ingredient that is highly digestible will be one of the key parameters. A more digestible raw material will contribute to the overall feed digestibility for the fish. Particularly, this will reduce the impact on waste that is released into the aquatic environment considering that less nondigested material will be discharged by the aquatic animal in the form of faeces.

Wheat protein, also known as wheat gluten, is one such candidate. It is well known for its nutritional, but also for its functional properties. Vital wheat gluten is already commonly used in the industry in the production of aqua feed pellets. Thanks to its excellent viscoelastic properties, vital wheat gluten can act as a binder helping to obtain a pellet with the right porosity, hardness and durability. The vital wheat gluten ingredient is shipped to the aqua feed manufacturers preferably in the form of pellets, which are ground before being incorporated into an extruded or pelletized aqua feed.

However, precisely due to the viscoelastic nature of vital wheat gluten it is challenging to increase the vital wheat gluten content above 20 wt % of the final pellet. Higher vital wheat gluten contents make the processability of the feed very difficult.

On the other hand, a devitalized wheat gluten in a powder form, commercially available for use in human food application, could be used instead of vital wheat gluten. By “devitalized” wheat gluten it is meant herein that the wheat gluten has lost its viscoelastic properties, according to the CODEX STAN 163-1987 “Devitalized wheat gluten is characterized by its reduced property of viscoelasticity as hydrated due to denaturation”. However, firstly, a devitalized wheat gluten powder alone will not work, as devitalized wheat gluten powder on its own does not have the viscoelastic/binding properties to help form the pellets in the first place. Secondly, commercially available devitalized wheat gluten exist only in the powder form developed specifically for human food applications. These are particularly expensive and generally have a high carbon footprint, making it unsuitable for use in aqua feed. Thirdly, the powder form is difficult to handle and to transport. It was also surprising for the inventors to realize that devitalized wheat gluten would not negatively impact the pellet quality of the aqua feed pellet, nor negatively impact the growth of the farmed aquatic animal or digestibility of the aqua feed pellet by the farmed aquatic animal.

Thus, there is a need to provide additional wheat protein in a new form, which can be easily incorporated into aqua feed, whilst maintaining good digestibility of the protein by the aquatic animal, as well as good processability and stability of the pellets.

There is also a need to provide additional wheat protein in a new form, which can be easily transported and handled by the aqua feed manufacturer.

There is furthermore a need to provide additional plant-based protein for aqua feed diets, which is obtained from more sustainable sources and represents a reduced carbon dioxide footprint, which is currently an unmet need in the industry.

### SUMMARY OF THE INVENTION

The invention thus covers a process for preparing a coarse devitalized wheat gluten composition comprising the following steps:
a) Heating (optionally with agitation) a vital wheat gluten composition comprising
   at most 50 wt % dry substance, preferably at most 35 wt %, more preferably at most 30 wt %,
   at least 75 wt % protein on a dry weight basis, preferably at least 80 wt %, more preferably at least 82 wt %, most preferably at least 90 wt %,
   and at least 50 wt % water, preferably at least 65 wt %, more preferably at least 70 wt %,
to obtain a devitalized wheat gluten composition,
b) Passing the devitalized wheat gluten composition through a particle size reducer (e.g. knives, plates, cutter, mixer, mincer, grinder, mill or any combination thereof) to reduce the particle size to obtain a wet coarse devitalized wheat gluten composition, and
c) Drying the wet coarse devitalized wheat gluten composition down to a water content of at most 14 wt %, preferably at most 10 wt %, more preferably at most 8 wt %.

The invention also covers a coarse devitalized wheat gluten composition obtained or obtainable from this process (i.e., from step c) wherein at least 50 wt % of the composition has a particle size of more than 150 microns and at most 1 cm.

Furthermore, the invention also covers a coarse devitalized wheat gluten composition wherein at least 50 wt % of the composition has a particle size of more than 150 microns and at most 1 cm and comprising
at least 75 wt % protein on a dry weight basis, preferably at least 80 wt %, more preferably at least 82 wt %, most preferably at least 90 wt %,
at most 14 wt % water, preferably at most 10 wt % water, more preferably at most 8 wt %.

Furthermore, the invention also covers a process for preparing an aqua feed product wherein the coarse devitalized wheat gluten composition according to the invention above is mixed with one or more other aqua feed ingredients, such as vital wheat gluten. The invention thus also covers an aqua feed product comprising the coarse devitalized wheat gluten composition according to the invention above and one or more other aqua feed ingredients, such as vital wheat gluten.

Finally, the invention also covers the use of the coarse devitalized wheat gluten composition according to the invention above to increase the content of wheat proteins in aqua feed pellets compared to aqua feed pellets comprising vital wheat gluten as the only wheat protein source, whilst maintaining the overall digestibility of any wheat proteins in the aqua feed pellets.

### FIGURES

FIG. 1 compares the Mixolab profile and viscoelastic behavior of the product according to the invention, namely coarse devitalized wheat gluten, with vital wheat gluten and hydrolyzed wheat protein products.

### DETAILED DESCRIPTION OF THE INVENTION

### 1. The Raw Material Vital Wheat Gluten

Vital wheat gluten (also called elastic gluten) is the water-insoluble protein fraction extracted from wheat flour by a wet process. The main proteins in vital wheat gluten are gliadin and glutenin. The wheat flour is washed with water until all or a majority of the starch has been removed, leaving the sticky insoluble gluten as an elastic mass. To obtain vital wheat gluten powder, the mass can be dewatered and gently dried whilst maintaining the vitality of the wheat gluten.

According to the process of the invention vital wheat gluten powder may be used as the starting material to prepare the vital wheat gluten composition in step (a). However, more preferably, to avoid the need of an additional drying step, a wet vital wheat gluten composition obtained directly from the starch removal washing steps can be used.

A vital wheat gluten composition as required in step (a) comprises:
at most 50 wt % dry substance, preferably at most 35 wt %, more preferably at most 30 wt % dry substance,
at least 75 wt % protein on a dry weight basis, preferably at least 80 wt %, more preferably at least 82 wt %, most preferably at least 90 wt % protein on a dry weight basis,
and at least 50 wt % water, preferably at least 65 wt %, more preferably at least 70 wt % water.

The above preferred amounts can be combined in all possible ways for all three features.

The protein content as disclosed herein is always measured according to the AOAC 990.03 method (DUMAS) and using a 6.25 protein factor.

The vital wheat gluten composition preferably essentially consists of vital wheat gluten and water. The vital wheat gluten in the composition essentially consists of protein. However, there may also be some non-relevant fat, fiber, starch and minerals present in the vital wheat gluten. Preferably, the vital wheat gluten in the composition is comprised of (or essentially consists of):
at least 75 wt % on a dry weight basis, preferably at least 80 wt %, more preferably at least 82 wt % of protein, most preferably at least 90 wt % of protein,
optionally less than 5 wt % on a dry weight basis, preferably from 0.01 to 5 wt %, more preferably from 0.1 to 4 wt %, most preferably from 0.2 to 3.5 wt % of fat and
optionally less than 5.0 wt % on a dry weight basis, preferably from 0.01 to 5 wt %, more preferably from 0.01 to 4 wt %, most preferably from 0.01 to 2 wt % of fiber, and
optionally less than 10 wt % on a dry weight basis, preferably from 0.01 to 10 wt %, more preferably from 0.01 to 9 wt %, most preferably from 0.01 to 8 wt % of starch, and
optionally less than 2 wt % on a dry weight basis, preferably from 0.001 to 2 wt %, more preferably from 0.01 to 2 wt %, most preferably from 0.1 to 2 wt % of minerals.

The above preferences can be combined in all possible ways for all the features.

The dry substance and water content of the vital wheat gluten composition is measured by
i. weighing 5 g of sample,
ii. air drying the 5 g of sample in an oven for 2 hours at 130° C.,
iii. and determining the amount of moisture lost by reweighing the sample after drying.

The protein content is measured according to the AOAC 990.03 method (DUMAS method) and using a 6.25 protein factor.

### 2. The Heating Step (a)

The vital wheat gluten composition is heated according to step (a). This can be done in any heating device suitable for devitalizing vital wheat gluten. The heating can occur with agititation.

The vital wheat gluten is thus devitalized by heat denaturation of the proteins in the composition. The composition obtained after this heating step is a devitalized wheat gluten composition. At least 80 wt %, preferably at least 90 wt %, more preferably at least 95 wt %, most preferably at least 99 wt % of the wheat gluten is devitalized by heating. Most preferably, the wheat gluten in the devitalized wheat gluten composition obtainable from step (a) has lost all of its viscoelastic properties. It is considered a devitalized wheat gluten according to the CODEX STAN 163-187 definition mentioned above.

The heating temperature is between 90° C. to 120° C., preferably 95° C. to 115° C.

The vital wheat gluten composition is heated for a duration necessary to devitalize preferably all the wheat gluten.

The vital wheat gluten composition can be heated with heated air or steam, microwave, radio frequency heating or a similar heating method. More preferably, the vital wheat gluten composition is heated in a surface scrape heat exchanger. The vital wheat gluten composition can be heated indirectly in a surface scrape heat exchanger with steam. However, the heating device is not an extruder nor a pelletizer (also known as a pellet mill). The heating device is also not a flash-dryer e.g., not a high-temperature flash-dryer.

Heating can occur together with agitation.

### 3. The Particle Size Reduction Step (b)

Before drying, the devitalized wheat gluten composition is size reduced. The devitalized wheat gluten composition average particle size is for instance reduced to produce a more homogenized feedstock. However, the objective is not to reduce the particle size down to a (fine) powder, but down to a coarse material, such that after the drying step (c) at least 50 wt % of the composition has a particle size of more than 150 microns and at most 1 cm.

Alternatively, the devitalized wheat gluten composition can additionally have a particle size distribution wherein at least 90 wt % of the composition has a particle size of at least 180 microns, preferably at least 95 wt %, more preferably at least 98 wt %, most preferably at least 98.5 wt %.

Alternatively, the devitalized wheat gluten composition can additionally have a particle size distribution wherein at most 10 wt % of the composition has a particle size of less than 180 microns, preferably at most 5 wt %, more preferably at most 2 wt %, most preferably at least 1.5 wt %.

The particle size and particle size distribution can be measured by sieving and mechanical shaking, for instance with a Retsch Sieve Shaker.

Surprisingly, it has been observed that the coarse material is easier to produce, handle and transport than devitalized wheat gluten powder.

Particle size reduction can be carried out using any known device suitable for reducing the particle size of a solid material. This can be for instance, static knives and plates, a cutter, a mixer, a mincer, a grinder or a mill or a combination thereof. Preferably, the particle size reduction device in this invention is a set of static knives and plates followed by a mixer, which are situated in the transfer line between the heating device and the drying device. Alternatively, the particle size reduction device in this invention is a cutter situated at the exit of the surface scrape heat exchanger.

The particle size reduction device is not part of an extruder nor a pelletizer (also known as a pellet mill).

### 4. The Drying Step (c)

The coarse devitalized wheat gluten composition obtained from step (b) is then dried down to a water content of at most 14 wt %, preferably at most 10 wt %, more preferably at most 8 wt % or at most 7 wt %, 6 wt % or 5 wt %.

The drying temperature, i.e., the temperature within the drying chamber, is between 70° C. to 130° C., preferably from 70° C. To 120° C., more preferably 70° C. to 110° C.

The drying step can be carried out in a dryer, such as a contact dryer or an air-steam dryer.

The contact dryer is preferably a vacuum dryer, preferably a vacuum disc dryer. The contact dryer (including a vacuum dryer, preferably a vacuum disc dryer) with an energy recovery system as described in WO2021042016 can be used. This renders the drying step considerably more energy efficient.

The drying device is not part of an extruder nor a pelletizer (also known as a pellet mill).

The drying duration depends on the temperature. The vital wheat gluten composition is heated for a duration necessary to dry the composition down to a water content of at most 14 wt %, preferably at most 10 wt %, more preferably at most 8 wt % or at most 7 wt %, 6 wt % or 5 wt %. Some minor amounts of water may remain e.g., at least 0.1 wt %, or at least 0.5 wt %, or at least 1 wt % or at least 1.5 wt % or at least 2 wt %.

### 5. The Dried Coarse Devitalized Wheat Gluten Composition

The coarse devitalized wheat gluten composition obtained from step (c) can then be easily packaged or transferred to containers or bags or into tanks ready for transport, in particular for transportation to the fish feed manufacturers. All of the disadvantages observed with transporting powdered devitalized wheat gluten, in particular dusting and explosion dangers, are thereby avoided.

At least 50 wt % of coarse devitalized wheat gluten composition, preferably obtainable from the process according to the invention, has a particle size of more than 150 microns, preferably at least 200 microns, more preferably at least 250 microns, most preferably at least 500 microns, at least 1000 microns, or at least 1300 microns and/or of at most 1 cm, preferably at most 0.8 cm, more preferably at most 0.5 cm, most preferably at most 0.3 cm and comprises:
at least 75 wt % protein on a dry weight basis, preferably at least 80 wt %, more preferably at least 82 wt %, most preferably at least 90 wt %; and
at most 14 wt % water, preferably at most 10 wt % water, more preferably at most 8 wt % water, or at most 7 wt %, 6 wt % or 5 wt %.

The above preferences can be combined in all possible ways for all the features.

Alternatively, the devitalized wheat gluten composition can additionally have a particle size distribution wherein at least 90 wt % of the composition has a particle size of at least 180 microns, preferably at least 95 wt %, more preferably at least 98 wt %, most preferably at least 98.5 wt %.

Alternatively, the devitalized wheat gluten composition can additionally have a particle size distribution wherein at most 10 wt % of the composition has a particle size of less than 180 microns, preferably at most 5 wt %, more preferably at most 2 wt %, most preferably at least 1.5 wt %.

The particle size and particle size distribution can be measured by sieving and mechanical shaking, for instance with a Retsch Sieve Shaker.

The coarse devitalized wheat gluten composition after drying may thus still have some amounts of water remaining in the composition. The coarse devitalized wheat gluten composition after drying can still comprise some water as described above e.g., at least 0.1 wt % water, at least 0.5 wt %, at least 1 wt %, at least 1.5 wt % or at least 2 wt %.

The coarse devitalized wheat gluten composition preferably essentially consists of devitalized wheat gluten and water.

Preferably, the devitalized vital wheat gluten in the devitalized wheat gluten composition obtained from the process according to the invention has (or essentially has) the same or similar nutrient profile as the vital wheat gluten in the vital wheat gluten composition used in step (a) and described above.

The main difference is the nature of the wheat gluten, which changes from vital to devitalized.

The devitalization can be verified using the Mixolab® device from Chopin technologies. More specifically using the standard Mixolab® protocol “Gluten 1”. This protocol developed by Chopin and described in the Mixolab® handbook entitled “Mixolab applications handbook-Rheological and Enzymatic Analysis” published by Chopin Technologies (created September 2006, Updated July 2009), provides a simple, effective and repeatable solution for evaluating wheat gluten properties. This protocol is adapted for determining the loss of vitality as described in the “Examples” section below.

When the rheological behavior of the starting material (i.e., the vital wheat gluten composition of step (a)) is evaluated according to the adapted protocol, this will typically lead to a torque response of above 2 Nm. However, when the rheological behavior of the devitalized wheat gluten composition according to the invention (i.e., from step (c)) is measured according to the adapted protocol, the torque response should remain below 1.2 Nm (or below 1.1 Nm) and be above 0.2 Nm (or above 0.3 Nm).

The capacity of the product to absorb and retain water is measured and described as water binding capacity. Devitalized wheat gluten can absorb more water than Vital wheat gluten on is coarse form and with less intensity on a milled form.

Water binding capacity is measured as of the the amount of water that the product can retain e.g., 1 g H2O per g product. Product is added on a centrifuge tube and soaked in water for a period of time. After a resting time, the mix is centrifuged and the supernatant is removed. The differences in weigh resulted in the amount of water captured by the material.

The process for preparing the dried coarse devitalized wheat gluten composition does not comprise an extrusion step or a flash-drying step. No extruder or pelletizer (pellet mill) or flash-dryer (e.g., high temperature flash dryer) is used in this process. Thus, the applicant was able to prepare coarse devitalized wheat gluten, which required surprisingly less energy consumption per kg of product than the preparation of vital wheat gluten pellets or devitalized wheat gluten powder.

### 6. Process for Preparing the Aqua Feed Product

The invention also covers a process for preparing an aqua feed product wherein coarse devitalized wheat gluten composition is prepared according to steps (a) to (c) above, followed by a step (d) wherein the coarse devitalized wheat gluten composition is then mixed with one or more other aqua feed ingredients, preferably selected from one or more of:
Aquatic animal-based protein, such as fishmeal and krill meal;
plant-based protein, such as soymeal, corn gluten meal, guar protein, pea protein, rapeseed meal and sunflower meal;
flours, for instance whole wheat flour, refined wheat flour or legume flours, such as faba flour or whole pea flour;
fish or plant-based oils;
minerals;
vitamins;
lecithin;
pigments;
and binders, such as vital wheat gluten.

The coarse devitalized wheat gluten composition, used to prepare the aqua feed product, wherein at least 50 wt % of the composition has a particle size of more than 150 microns and at most 1 cm, comprises:
at least 75 wt % protein on a dry weight basis, preferably at least 80 wt %, more preferably at least 82 wt %, most preferably at least 90 wt % protein, and
at most 14 wt % water, preferably at most 10 wt % water, more preferably at most 8 wt % water.

The coarse devitalized wheat gluten composition preferably essentially consists of devitalized wheat gluten and water.

The aqua feed product can be prepared by standard extrusion or pelletizing techniques known to the person skilled in the art.

### 7. The Aqua Feed Product

The invention thus also covers an aqua feed product comprising a coarse devitalized wheat gluten composition, wherein at least 50 wt % of the coarse devitalized wheat gluten composition has a particle size of more than 150 microns and at most 1 cm and the composition comprises
at least 75 wt % protein on a dry weight basis, preferably at least 80 wt %, more preferably at least 82 wt %, most preferably at least 90 wt % and
at most 14 wt % water, preferably at most 10 wt % water, more preferably at most 8 wt % water.
   and one or more other aqua feed ingredients, preferably from the list provided above under section 6.

The aqua feed product thus comprises a coarse devitalized wheat gluten composition obtainable from the process of the invention and one or more other aqua feed ingredients, preferably from the list provided above under section 6.

The aqua feed product can be in the form of pellets, preferably prepared by standard extrusion or pelletizing techniques known to the person skilled in the art.

The aqua feed product can be a product suitable for feeding farmed:
Fish, such as salmon, trout, carp, tilapia, tuna, catfish, bream, eel, sturgeons and the like;
Crustaceans, such as shrimp/prawn (e.g., the Pacific white shrimp or the giant tiger prawn), lobster, crab, crayfish and the like.

The aqua feed product can comprise at least 0.1 wt % of the coarse devitalized wheat gluten composition of the invention, preferably at least 0.5 wt %, more preferably at least 1 wt %, most preferably at least 2 wt %. The aqua feed product can comprise at most 50 wt % of the coarse devitalized wheat gluten composition of the invention, preferably at most 25 wt %, more preferably at most 20 wt %, most preferably at most 15 wt %. The aqua feed product can comprise from 0.1 wt % to 50 wt % of the coarse devitalized wheat gluten composition of the invention, preferably 0.5 wt % to 25 wt %, more preferably from 1 wt % to 20 wt %, most preferably from 2 wt % to 15 wt %.

In addition to the coarse devitalized wheat gluten composition of the invention, the aqua feed product can also comprise at least 0.1 wt % vital wheat gluten, preferably at least 0.5 wt %, more preferably at least 1 wt %, most preferably at least 1.5 wt %, or at least 2 wt % or at least 5 wt % vital wheat gluten. The aqua feed product can comprise at most 20 wt % of vital wheat gluten, preferably at most 18 wt %, more preferably at most 15 wt %, most preferably at most 12 wt %.

The aqua feed product can comprise from 0.1 wt % to 20 wt % of a binder (preferably vital wheat gluten but also others are possible), preferably 0.5 wt % to 18 wt %, more preferably from 1 wt % to 15 wt %, most preferably from 2 wt % to 12 wt %.

The aqua feed product can also have vital wheat gluten to devitalized wheat gluten weight ratio of from 10:90 to 90:10, preferably 30:70 to 70:30, more preferably 40:60 to 60:40, most preferably around 50:50.

Without being bound by theory, the vital wheat gluten is preferably used as a binder thanks to its viscoelastic properties. However, due to this functionality, there is an upper limit for how much vital wheat gluten can be introduced into an aqua feed product.

The invention overcomes the above-mentioned difficulties by using coarse devitalized wheat gluten. Coarse devitalized wheat gluten suitable for use by the aqua feed industry does not exist on the market today. It has been surprisingly found that coarse devitalized wheat gluten according to the invention requires less energy consumption for its preparation than pellets, is easier to transport and handle than a powder, and finally can be used to replace other protein sources, such as vital wheat gluten or soy protein, in the final aqua feed product without affecting the overall digestibility of the product or the growth of the aquatic animal.

Thus, the invention also covers the use of the coarse devitalized wheat gluten composition according to invention as described above to increase the content of wheat proteins in an aqua feed product compared to an aqua feed product comprising vital wheat gluten as the only wheat protein source, whilst maintaining the overall digestibility and/or growth performance potential and/or pellet quality and/or processability of the aqua feed product.

The invention also covers the use of coarse devitalized wheat gluten composition as described above to replace other proteins in an aqua feed product, whilst maintaining the overall digestibility and/or growth performance potential and/or pellet quality and/or processability of the aqua feed product.

Digestibility can be measured by collecting the faeces and calculating the Apparent Digestibility Coefficient (ADC), according to Bureau et al., Aquaculture 180 (1999) 345-358.

Total performance can be evaluated by measuring weight gain and/or mortality and/or feed utilization and/or flesh quality of the farmed aquatic animal.

Pellet quality can be measured by in terms of Holmen durability and/or Doris durability and/or fat seepage and/or water stability.

Processability can be measured in terms of the die pressure at the die plate and/or by measuring the extruder's energy consumption in kW per hour.

### EXAMPLES

### 1. Preparation of the Coarse DWG (Coarse Devitalized Wheat Gluten)

### a). Heating Step:

100 kg of a vital wheat gluten composition consisting of:
30 wt % Gluvital® 21020 from Cargill comprising a protein content of 82 wt % on a dry weight basis (measured using the AOAC 990.03 method and using a 6.25 protein factor) and
70 wt % water
   was heated in SURFACE SCRAPE HEAT EXCHANGER (SSHE) to obtain a devitalized wheat gluten composition. The temperature in the SSHE was set to between 100 to 110° C. and the composition was heated for a duration of about 10 minutes.

### b). Size Reducing Step:

The wet and fully devitalized wheat gluten composition obtained from the heating step was then passed through a set of static knives and plates followed by a mixer positioned between the SSHE and the dryer to reduce the particle size to obtain a wet coarse devitalized wheat gluten composition. The composition was cut in order to obtain a composition after drying wherein at least 50 wt % of the composition had a particle size of more than 150 microns and at most 1 cm.

### c). Drying Step:

The wet coarse devitalized wheat gluten composition was then dried in a vacuum disc dryer, a type of contact dryer. This dryer was incorporated into an energy recovery system as described in WO2021042016. This renders the drying step considerably more energy efficient.

The temperature in the vacuum disc dryer was set to 70-90° C.

The water content of the wet coarse devitalized wheat gluten composition was then reduced down to 8 wt % to obtain a dried coarse devitalized wheat gluten composition, according to the invention.

At least 50 wt % of the final coarse devitalized wheat gluten composition had a particle size of more than 150 microns and at most 1 cm.

### Measuring Vitality of the Coarse Devitalised Wheat Gluten Product:

The wheat gluten in the final coarse devitalized wheat gluten product is completely devitalized, which can be verified using the Mixolab® device from Chopin Technologies. More specifically using the standard Mixolab® protocol “Gluten 1”. This protocol developed by Chopin and described in the Mixolab® handbook already mentioned above, provides a simple, effective and repeatable solution for evaluating wheat gluten properties.

Since the devitalized wheat gluten obtained using the process of the invention is in the form of a coarse product, the product was milled to obtain a particle size of less than 200 microns (i.e., so that all particles passed through a 200 micron sieve) prior to analysis to minimize damage to the device.

When using the standard Mixolab® “Gluten 1” protocol for measuring the vitality of wheat gluten according to this invention an optimization of the protocol is done by increasing the total mass (g) of sample to 85 g in total (instead of the 75 g disclosed in the protocol). In this way the measurement of the dough behavior for a devitalized type of product is optimized.

When the rheological behavior of vital wheat gluten, such as Gluvital® 21020 (which does not require milling for the analysis since it already has a particle size of less than 200 microns), is evaluated under the adapted protocol, this will lead to a torque response of above 2 Nm. However, when the rheological behavior of a devitalized wheat gluten is measured under the adapted protocol, the torque response will be below 1.2 Nm and above 0.2 Nm.

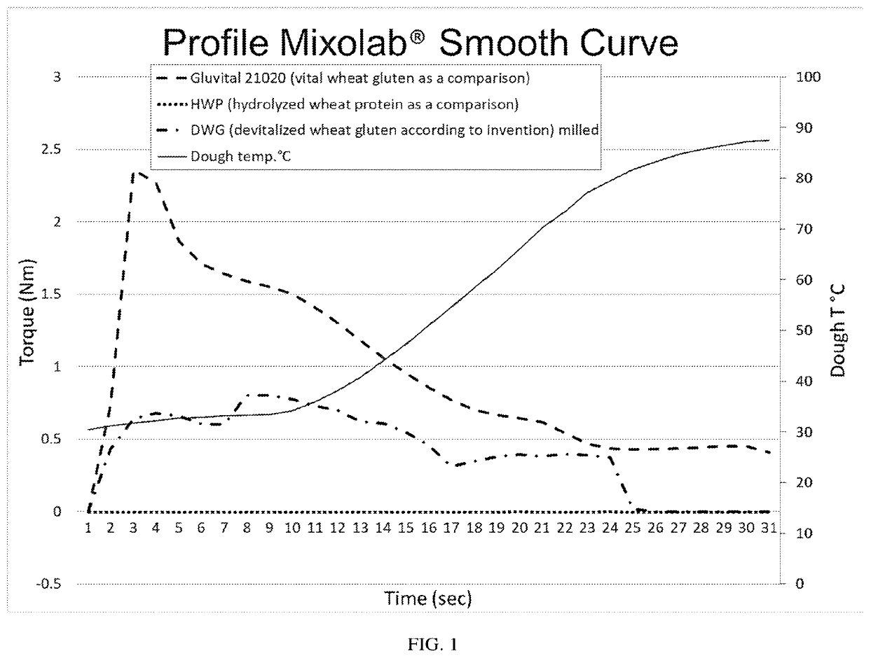

When plotting the comparison of Mixolab® results with the adapted “Gluten 1” protocol for a vital wheat gluten composition (used in the starting material from step (a) i.e. Gluvital® 21020), a devitalized wheat gluten composition (product obtained from step (c) after drying) and a hydrolyzed wheat gluten composition (known vital wheat gluten that has been chemically or enzymatically hydrolyzed) onto a graph, the different rheological behavior is clearly observed (See FIG. 1). Thus the difference in elasticity and binding capabilities were clearly demonstrated for the “devitalized” wheat gluten with lost elasticity compared to the “vital” starting material.

About 32 kg of coarse devitalized wheat gluten was obtained using this method having an 8 wt % moisture content. This was obtained without using any extrusion processes.

This coarse devitalized wheat gluten according to the invention was then tested in the following aqua feed extrusions to prepare salmon feed diets for digestibility, growth and mortality trials as described further below.

### 2. Extrusion Trials

Two different aqua feed products Diet 1 and Diet 2 (with the ingredient profiles as shown below using different types and amounts of wheat protein sources) and comparative trials were prepared by extrusion using the following equipment and parameters.

Dry ingredients were first mixed in a standard mixer. The resulting blend was then transported to the preconditioner of the extruder below with the addition of water and steam as identified below and finally extruded:
Extruder model: Wenger X85
Die diameter: 6.5 mm
Feed rate: 125 kg/h with 7-8 wt % moisture
Preconditioner:
   Water: 23.55 wt % (29.44 kg/h added in addition to the feed above)
   Steam: 11.38% (14.23 kg/h added in addition to the feed above)
Speed RPM: 431.74 rounds per minute
Outlet T° of preconditioner: 94.98° C.
Outlet T° at the die: 142.3° C.

### Comparative Trials for Process Parameters and Pellet Quality:

Pilot extrusion trials were carried out to compare coarse DWG to powder and pelleted VWG, in terms of their effects on extrusion process and the physical quality of salmon feed pellets. The data from these comparative extrusion trials showed that there were no significant differences in major process parameters (e.g., specific energy consumption or pressure at the die plate etc.) nor in the pellet quality parameters between the 3 different wheat protein sources. Surprisingly, the coarse DWG performed just as well as the VWG in powder or pellet form. This was unexpected.

| | | Extruded pellets | Extruded | Extruded |
|---|---|---|---|---|
| | | with 10 wt % coarse | pellets with | pellets with |
| | | DWG according to | 10 wt % VWG | 10 wt % VWG |
| | | the invention | powder | pellets |
| Process | Pressure at the | 16.56 | 17.23 | 18.36 |
| parameters | die plate (bar) | | | |
| | Extruder energy | 7.38 | 7.15 | 7.42 |
| | consumption | | | |
| | (kW) | | | |
| Pellet | Doris Durability | 85 | 86 | 92 |
| quality | (%) | | | |
| | Holmen | 75 | 77 | 76 |
| | Durability (%) | | | |
| Pellet | Diameter (mm) | 8.57 | 8.99 | 9.01 |
| size | Expansion (%) | 31.89 | 38.35 | 38.60 |

Pellet durability is measured by the Doris method.

Pellet durability index PDI is measured using Holmen tester for a duration of 120 s.

Pellet size is measured by micrometer and expansion is calculated as the ratio between the pellet diameter and the extruder die diameter.

### 3. Digestibility Trials

The main purpose of this trial was to determine the nutrient digestibility of the new wheat protein described as ADC % considered to be used in salmon feed.

All diets were fed to Atlantic Salmon (ATS) (weighing on average 700 g+−/200 g each) in marine water tanks for 2 weeks.

The salmon were fed 3-4 times a day. Feed quantity based on body weight and expected growth.

Diets were designed using a “balanced base mix” and adding on top the wheat protein composition (the coarse devitalized wheat gluten (DWG) according to the invention from Example 1 above, vital wheat gluten pellets (VWG powder) or vital wheat gluten powder (VWG pellets)) to be evaluated. The reference raw material is high quality fish meal (FM).

### Balanced Base Mix:

| Ingredient name | Base diet |
|---|---|
| Aquatic animal | 42 |
| proteins including | |
| fish meal | |
| Total plant proteins | 29.6 |
| Micronutrients | 1.4 |
| Oils | 27 |
| TOTAL | 100 |

| Diet | Diet 1 (ref) | Diet 1a | Diet 1b | Diet 1c |
|---|---|---|---|---|
| Base mix | 85 | 85 | 85 | 85 |
| FM | 15 | | | |
| VWG | | | 15 | |
| powder | | | | |
| DWG | | 15 | | |
| VWG pellets | | | | 15 |
| Total | 100 | 100 | 100 | 100 |

Diet 1 for the digestibility tests:
1. Diet 1 Ref: using fish meal at 15 wt % above balanced base mix.
2. Diet 1 a: using coarse devitalized wheat gluten (DWG) according to the invention from Example 1 at 15 wt % above balanced base mix.
3. Diet 1 b: using Cargill commercial VWG in powder form at 15 wt % above balanced base mix.
4. Diet 1 c: using Cargill commercial VWG in pellet form at 15 wt % above balanced base mix.

Digestibility was measured by collecting the faeces and calculating the Apparent Digestibility Coefficient of the test ingredient (ADC), according to Bureau et al., Aquaculture 180 (1999) 345-358.

| Raw material | |
|---|---|
| Name | ADC % |
| Diet 1 Ref | 88.9 |
| Diet 1 a | 95.6 |
| Diet 1 b | 95.4 |
| Diet 1 c | 96.6 |

The new coarse DWG according to the invention performed surprisingly just as well in the digestibility trials as the other conventionally used vital wheat gluten products.

### 4. Performance Trials (Growth and Mortality)

Main purpose of this trial was to evaluate the biological performance of the new ingredient added into a balanced base diet. This performance is assessed by means of growth and survival.

All diets were fed to small Atlantic Salmon (ATS) (average 3.11 grams) in freshwater tanks for 8 weeks.

The salmon were fed 3-4 times a day, feed quantity according to biomass.

### Diet 2:

| | Reference | Diet 2a | Diet 2b | Diet 2c |
|---|---|---|---|---|
| Ingredient name | FM | DWG | VWG powder | VWG pellet |
| Aquatic animal | 58.5 | 20 | 19.6 | 19.7 |
| proteins including | | | | |
| fish meal | | | | |
| Plant proteins | 24.46 | 47.3 | 47.3 | 47.4 |
| DWG | | 15 | | |
| VWG | | | 15 | |
| powder | | | | |
| VWG | | | | 15 |
| pellets | | | | |
| Micronutrients | 5.1 | 5.8 | 5.9 | 5.9 |
| Oils | 11.94 | 11.9 | 12.2 | 12 |
| TOTAL | 100 | 100 | 100 | 100 |

Diet 2 for biological performance evaluation:
1. Treatment 1—Ref.diet: balanced commercial diet.
2. Treatment 2—Diet 2a: balanced diet with 15% addition of coarse devitalized wheat gluten (DWG) according to the invention from Example 1, thereby replacing some of the fish meal and soy protein.
3. Treatment 3—Diet 2b: balanced diet with 15% addition of Cargill commercial VWG in powder form, replacing some of the fish meal and soy protein.
4. Treatment 4—Diet 2c: balanced diet with 15% addition of Cargill commercial VWG in pelleted form, replacing some of the fish meal and soy protein.

Fish performance was measured after 6 weeks.

Average Weight Gain after 6 Weeks (g):

| | Average weight gain |
|---|---|
| Diet Name | (g) |
| Diet 2 Ref | 23.03 |
| Diet 2 a | 20.52 |
| Diet 2 b | 21.32 |
| Diet 2 c | 22.26 |

### Proportional Growth (%) Compared to the Reference Diet:

| Diet Name | Mean |
|---|---|
| Diet 2 Ref | 1 |
| Diet 2 a | 0.90 |
| Diet 2 b | 0.93 |
| Diet 2 c | 0.97 |

The coarse DWG according to the invention achieved+/−90% proportional growth, which is in an acceptable range.

Mortality was assessed after 8 weeks.

| | | | Number | | |
|---|---|---|---|---|---|
| | | Number of | of fish | Accumulated | % Accumulated |
| Feed | Name | tanks | at start | mortality | mortality |
| 1 | Diet 2 Ref | 4 | 322 | 2 | 0.62 |
| 2 | Diet 2 a | 4 | 319 | 4 (all in | 1.25 |
| | | | | 1 tank) | |
| 3 | Diet 2 b | 4 | 320 | 3 | 0.94 |
| 4 | Diet 2 c | 4 | 319 | 2 | 0.63 |

The mortality was low for all diets. Note: The slightly higher mortality observed for Diet 2a probably derives from other parameters than the diet, as the mortality was zero in three of the four tanks from this diet.

All the tested wheat glutens performed well in the digestibility trial and the performance trial.

In summary, the coarse devitalized wheat gluten product according to the invention is a surprisingly good alternative to vital wheat gluten in salmon feed not only in relation to processability and pellet quality, but also in relation to growth, mortality and digestibility in the salmon. This was surprising, since the devitalized wheat gluten has very different physical properties compared to vital wheat gluten.

Thus, the coarse devitalized wheat gluten according to the invention can be used to replace aquatic animal proteins, such as fish meal, as well as other plant proteins, such as soy protein. Coarse devitalized wheat gluten can be a more sustainable source of protein in the manufacture of aqua feed.

1. A process for preparing a coarse devitalized wheat gluten composition comprising the following steps:
a) Heating a vital wheat gluten composition comprising
at most 50 wt % dry substance, preferably at most 35 wt %, more preferably at most 30 wt %,
at least 75 wt % protein on a dry weight basis, preferably at least 80 wt %, more preferably at least 82 wt %, most preferably at least 90 wt %,
and at least 50 wt % water, preferably at least 65 wt %, more preferably at least 70 wt %,
to obtain a devitalized wheat gluten composition,
b) Passing the devitalized wheat gluten composition through a particle size reducer to reduce the particle size to obtain a wet coarse devitalized wheat gluten composition, and
c) Drying the wet coarse devitalized wheat gluten composition down to a water content of at most 14 wt %, preferably at most 10 wt %, more preferably at most 8 wt % to obtain a coarse devitalized wheat gluten composition.

2. The process according to claim 1 wherein the process does not comprise an extrusion step.

3. The process according to claim 1 wherein in step (a) the heating step is carried out in a surface scrape heat exchanger.

4. The process according to claim 1 wherein the particle size reducer is a cutter, mincer, mixer, grinder, or mill.

5. The process according to claim 1 wherein at least 50 wt % of the coarse devitalized wheat gluten composition obtained from step (c) has a particle size of more than 150 microns and at most 1 cm and/or wherein at least 90 wt % of the composition has a particle size of at least 180 microns.

6. The process according to claim 1 wherein in step (c) the drying is carried out in a contact dryer or in an air-stream dryer.

7. The process according to claim 6 wherein the contact dryer is a vacuum dryer, preferably a vacuum disc dryer.

8. A coarse devitalized wheat gluten composition obtainable from the process of claim 1.

9. A coarse devitalized wheat gluten composition wherein at least 50 wt % of the composition has a particle size of more than 150 microns and at most 1 cm and comprising
at least 75 wt % protein on a dry weight basis, preferably at least 80 wt %, more preferably at least 82 wt %, most preferably at least 90 wt %,
at most 14 wt % water, preferably at most 10 wt % water, more preferably at most 8 wt %,
optionally, wherein at least 90 wt % of the composition has a particle size of at least 180 microns.

10. The composition according to claim 8, wherein the composition essentially consists of devitalized wheat gluten and water.

11. A process for preparing an aqua feed product wherein the coarse devitalized wheat gluten composition of claim 8 is mixed with one or more other aqua feed ingredients, preferably selected from aquatic animal-based protein, such as fishmeal and krill meal; plant-based protein, such as soymeal, corn gluten meal, guar protein, pea protein, rapeseed meal and sunflower meal; wheat flours, such as whole wheat flour or refined wheat flour; legume flours such as pea protein flour and faba flour; fish or plant-based oils; minerals; vitamins; lecithin; pigments; and binders, such as vital wheat gluten.

12. An aqua feed product comprising the coarse devitalized wheat gluten composition according to claim 8 and one or more other aqua feed ingredients.

13. The aqua feed product according to claim 12 wherein the one or more other aqua feed ingredients are selected from aquatic animal-based protein, such as fishmeal and krill meal; plant-based protein, such as soymeal, corn gluten meal, guar protein, pea protein, rapeseed meal and sunflower meal; wheat flours, such as whole wheat flour or refined wheat flour; legume flours, such as pea protein flour and fava flour; fish or plant-based oils; minerals; vitamins; lecithin; pigments; and binders, such as vital wheat gluten.

14. The aqua feed product according to claim 12 wherein the aqua feed product comprises from 0.1 wt % to 20 wt % of vital wheat gluten and from 0.1 wt % to 50 wt % of the coarse devitalized wheat gluten composition of claim 8 or 9.

15. The aqua feed product according to claim 12 wherein the aqua feed product comprises vital wheat gluten to devitalized wheat gluten in a weight ratio of from 10:90 to 90:10, preferably 30:70 to 70:30, more preferably 40:60 to 60:40.

16-17. (canceled)
